(19) United States
(12) Patent Application Publication
(10) Pub. No.: US 2016/0125159 A1
(43) Pub. Date: May 5, 2016

(54) SYSTEM FOR MANAGEMENT OF HEALTH RESOURCES

(71) Applicant: Healthcare Business Intelligence Solutions Inc., Palo Alto, CA (US)

(72) Inventors: Bruce X. Ling, Palo Alto, CA (US); Karl G. Sylvester, Menlo Park, CA (US); Eric C. Widen, San Francisco, CA (US)

(73) Assignee: Healthcare Business Intelligence Solutions Inc., Palo Alto, CA (US)

(21) Appl. No.: 14/933,967

(22) Filed: Nov. 5, 2015

Related U.S. Application Data
(60) Provisional application No. 62/075,779, filed on Nov. 5, 2014.

(51) Int. Cl. G06F 19/00

(52) U.S. Cl. CPC G06F 19/3431; G06F 19/322

(57) ABSTRACT

A computer implemented method of identifying individuals having a predicted susceptibility and/or level of risk to repeated visits to a medical facility within a defined time period following an initial visit is provided. The method includes accessing an evaluation data store of historical patient data representing clinical history of each patient in the patient population. A risk score is calculated for each patient. The risk score based on a computation created from a modeling data store including a first data set comprising a history of medical facility visits accessed from a health information exchange. In the modeling data store, each visit is characterized by a set of factors, and the risk factor is calculated based on a subset of factors computationally selected based on a likelihood of each factor selected producing a medical facility visit. The risk factor can then be used in a number of different analyses.

### CLAIM OF PRIORITY

Priority is claimed to U.S. Provisional Patent Application Ser. No. 62/075,779 filed Nov. 5, 2014, incorporated fully herein.

### BACKGROUND

The rapid growth of healthcare facility visits, and particularly emergency department visits, in last few years in United States demands larger healthcare resources than ever. The population vulnerable to return visits is therefore of public interest, especially with regard to healthcare beneficiaries concerned with decreasing morbidity and costs. Accurate prediction of emergency department (ED) return visits is may assist cost-effective resource allocation planning seeking to improve post discharge intervention in high-risk patients. Currently used prediction models have limitations. They either rely on data systems biased by the high rate of previous ED admissions that do not necessarily correlate with ongoing risk for future ED admission, or focus on patients within specific payer groups, within specific age groups, and/or within specific disease groups.

The development of electronic medical record (EMR) systems and health information exchanges (HIE) in US makes clinical information available covering a broad scope of patients of all payers, all ages, and all diseases.

### SUMMARY

The technology, briefly described, provides a computer implemented method of identifying individuals having a predicted susceptibility and/or level of risk to repeated visits to a medical facility within a defined time period following an initial visit is provided. The method includes accessing an evaluation data store of historical patient data representing clinical history of each patient in the patient population. A risk score is calculated for each patient. The risk score based on a computation created from a modeling data store including a first data set comprising a history of medical facility visits accessed from a health information exchange. In the modeling data store, each visit is characterized by a set of factors, and the risk factor is calculated based on a subset of factors computationally selected based on a likelihood of each factor selected producing a medical facility visit. The risk factor can then be used in a number of different analyses.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a system suitable for implementing the present technology showing a number of processing systems coupled to and communicating through a network.

FIG. 2 depicts a block diagram of any of the processing devices of FIG. 1.

FIG. 3 is a flow chart illustrating a method in accordance with the present technology.

FIG. 4 is a flowchart illustrating step 318 in FIG. 3.

FIG. 5 is a flowchart illustrating selection of features from medical data for prospective modeling

FIG. 6 is a table summarizing the features used in the medical data utilized herein to create the predictive model.

FIG. 7 is a graph illustrating the weighting vs. probability for certain types of features used in the predictive model.

FIG. 8 is a graph of observed rates of future 30-day ED returns versus risk scores in prospective tests.

FIG. 9 is a graph illustrating the sensitivity of the predictive model versus the number of features used in the model.

FIG. 10 is a graph illustrating future 30-day resource utilization analysis as a function of risks.

FIG. 11 is a graph illustrating a prospective case study on monthly ED visits and risks for a patient.

### DETAILED DESCRIPTION

Technology is provided to identify individuals (patients) who have a predicted susceptibility and/or level of risk to repeated visits to a medical facility within a defined time period following an visit. The technology may be implemented in a computer (or a number of computers) and employs predictive modeling to reduce healthcare costs while assisting patients by helping healthcare providers, insurers, or other providers identify patients or patient populations who are most likely to incur future events. Predictive modeling may also allow healthcare providers to identify which patients will likely consume the most resources in the future as a result of such subsequent visits.

The technology provides a computer implemented modeling application implemented in a processing device which is suitable for use on different respective data sets of patients to allow healthcare managers to characterize risks of patients' returning to a healthcare facility within a given time period after one or more visits to a healthcare facility. In one embodiment, the technology enables the aforementioned risk assessment to determine a risk of a patient returning to an emergency room within about 30 days following an emergency room visit. The application accesses a healthcare information (evaluation) dataset which includes patient data characterized by a set of factors. In one embodiment the set has over 14,000 such factors. The application performs a risk assessment based on a subset—in one embodiment 127 factors—of the factors for each patient in the health dataset, and for each day following the last discharge of the patient. The risk assessment can be used to provide further analysis of the data including validating predictive risks, classification of patients into risk groups, clustering of patients into sub-populations and evaluation of economic risks for future events in the evaluation dataset population. The technology identifies individuals within such a population who are at the highest risk of incurring risk events. According to one advantage, the technology applies predictive statistical modeling to patient data, and also takes into account geographic factors.

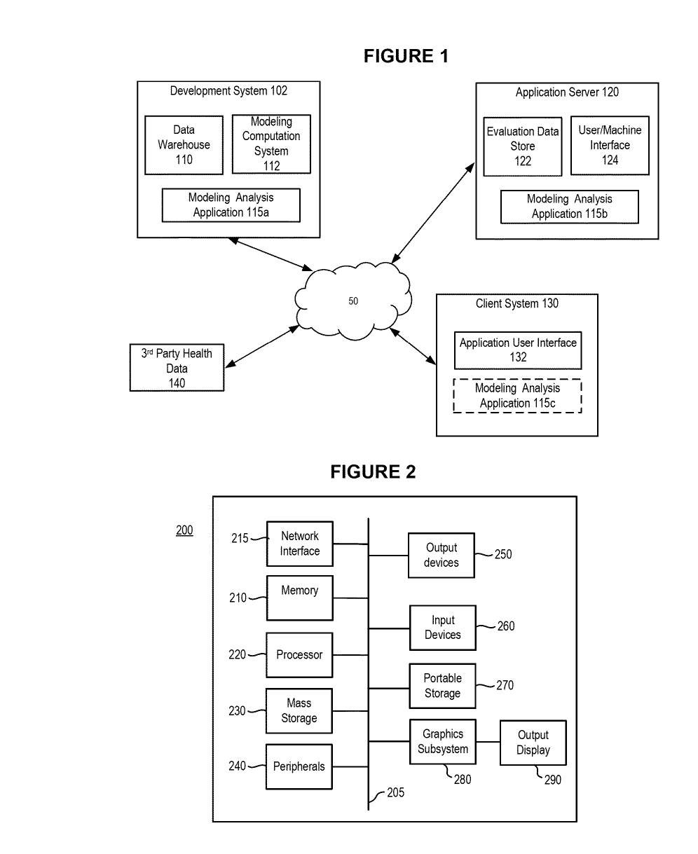

FIG. 1 illustrates a computer environment suitable for use in implementing the present technology. FIG. 1 illustrates three processing systems 102, 120, 130 connected to and adapted to communicate through a network 50.

A first processing system is indicated as being a development system 102. A second processing system is indicated as being an application server 120. A third processing system is indicated as being a client system 130. It should be understood that although three systems are illustrated in FIG. 1, only one system need be utilized to implement the technology described herein. Also illustrated in FIG. 1 is third-party health data store 140. Third-party health data store 140 may comprise a health information exchange as described herein.

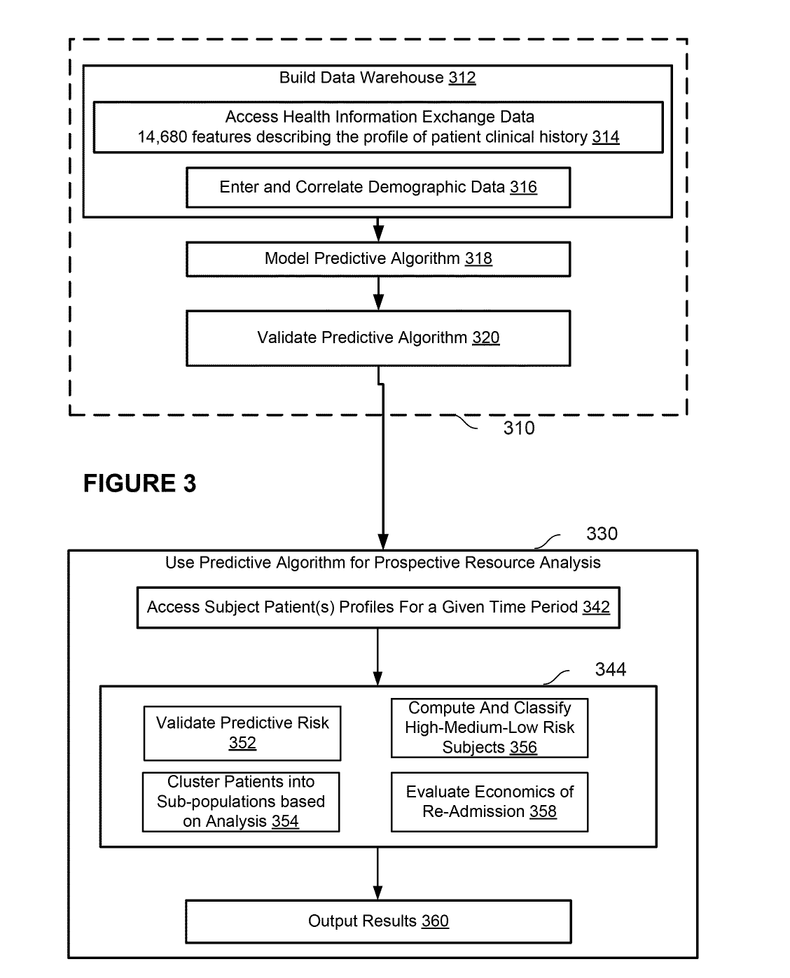

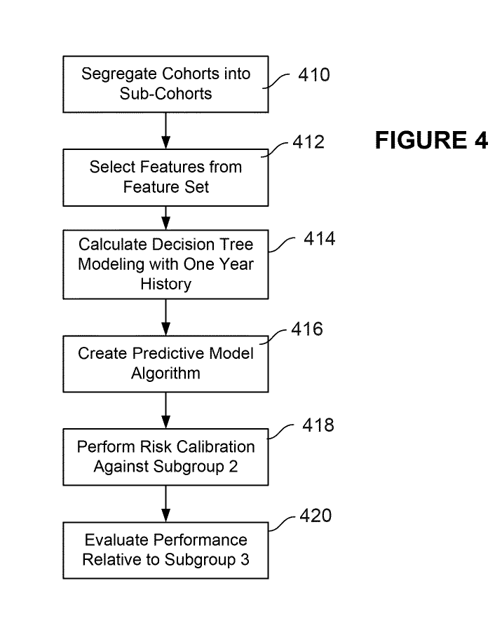

Described below with respect to FIG. 3 is a method for developing a predictive model. In one embodiment, the predictive model is developed by a model developer on a development system 102. It should be understood that the development of the predictive model as described herein may take place on any of the processing devices illustrated in FIG. 1. Third-party health data in health data store 140 is used to construct a data warehouse 110. Although the data warehouse 110 is illustrated as part of the development system 102, the warehouse 110 need not be part of the development system as such, and may be on any storage medium accessible to the development system 102. Modeling system 112 may to be utilized to create a predictive model in accordance with the discussion herein. The modeling system 112 may be an application programmed to perform the modeling computations described with respect to FIGS. 3 and 4 in order to create a predictive model. Once developed, the predictive model may be incorporated into a modeled analysis application 115. Development system 102 may distribute a model analysis application 115 to application server 120 and client system 130.

Three instances of the modeled analysis application 115 are illustrated in FIG. 1: the model analysis application 115 may be resident on the development system 102 (model analysis application 115a), the application server 120 (model analysis application 115b), and client system 130 (model analysis application 115c). Not all instances may be present in any one embodiment of the technology. In one embodiment, a user operating client system 130 may access the model analysis application 115b via an application user interface 132 on the client system 130. In another embodiment, the application user interface may access the modeled analysis application 115c operating on the client system 130.

Application server 120 includes a user or machine interface 124. The user/machine interface 124 may comprise communication components allowing the application server 120 to communicate with a client system 130 and development system 102. The interface 124 may include, for example, an application server component such as a Web server which allows the client system 130 access to the modeled analysis application 115b resident on the application server 120. Application user interface 132 may be, for example, a web browser which is utilized to access the model analysis application 115b.

Application server 120 also includes an evaluation data store 122 which may include health information data on one or more individuals for whom predictive analysis may be performed.

In one embodiment, a user interacts with client system 130 through the application user interface 132 to access modeled analysis application 115b on application server 120. An alternative embodiment, the model application analysis 115c is present on the client system 130 and client system 130 may access evaluation data store 122 via a network 50, or the evaluation data store 122 may be resident on the client system 130. As such, the modeled analysis application 115 implements the predictive model described herein one data in the application data store 122 under the instruction of one or more users of a modeled analysis application 115 via direct access on a processing device (such as application 115b on server 120 accessing data store 122 or via an interface 132 accessing application 115b or via an application 115c on a client device 130,) allowing any one or more users to compute the various types of analyses described herein to provide predictive outputs as described herein.

Development system 102, application server 120, client system 130 and third-party health data 140 may communicate via a network 50 which may comprise a plurality of public and private networks such as the Internet. Network 50 may comprise a completely private network or a completely public network.

FIG. 2 illustrates a high level block diagram of a computer system 200 that can be used to implement the present technology and any of the processing devices of FIG. 1. The computer system 2100 in FIG. 2 includes processor unit 220 and main memory 210. Processor unit 220 may contain a single microprocessor, or may contain a plurality of microprocessors for configuring the computer system as a multi-processor system. Main memory 210 stores, in part, instructions and data for execution by processor unit 220. If the system of the present technology is wholly or partially implemented in software, main memory 210 can store the executable code when in operation. Main memory 210 may include banks of dynamic random access memory (DRAM) as well as high speed cache memory.

The system of FIG. 2 further includes mass storage device 230, network interface 215 peripheral device(s) 240, user input device(s) 260, portable storage medium drive(s) 270, graphics subsystem 280, and output display 290. For purposes of simplicity, the components shown in FIG. 2 are depicted as being connected via a single bus 205. However, the components may be connected through one or more data transport means. For example, processor unit 220 and main memory 210 may be connected via a local microprocessor bus, and the mass storage device 230, peripheral device(s) 240, portable storage medium drive(s) 270, and graphics subsystem 280 may be connected via one or more input/output (I/O) buses. Mass storage device 230, which may be implemented with a magnetic disk drive or an optical disk drive, is a non volatile storage device for storing data and instructions for use by processor unit 220. In one embodiment, mass storage device 230 stores the system software for implementing the present technology for purposes of loading to main memory 210. The storage devices may variety of computer readable media. Computer readable media can be any available media that can be accessed by computer 200. By way of example, and not limitation, computer readable media may comprise computer storage. Computer storage media includes both non-volatile removable and non-removable media for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 200.

Portable storage medium drive 270 operates in conjunction with a portable nonvolatile storage medium, such as a flash drive, to input and output data and code to and from the computer system of FIG. 2. In one embodiment, the system software for implementing the present technology is stored on such a portable medium, and is input to the computer system via the portable storage medium drive 270. Peripheral device(s) 240 may include any type of computer support device, such as an input/output (I/O) interface, to add additional functionality to the computer system. For example, peripheral device(s) 240 may include a network interface for connecting the computer system to a network, a modem, a router, etc.

User input device(s) 260 provide a portion of a user interface. User input device(s) 260 may include an alpha-numeric keypad for inputting alpha-numeric and other information, or a pointing device, such as a mouse, a trackball, stylus, or cursor direction keys. In order to display textual and graphical information, the computer system of FIG. 2 includes graphics subsystem 280 and output display 290. Output display 290 may include a any type of conventional display device. Graphics subsystem 280 receives textual and graphical information, and processes the information for output to display 290. Additionally, the system of FIG. 2 includes output devices 250. Examples of suitable output devices include speakers, printers, network interfaces, monitors, etc.

The components contained in the computer system of FIG. 2 are those typically found in computer systems suitable for use with the present technology, and are intended to represent a broad category of such computer components that are well known in the art. Thus, the computer system of FIG. 2 can be a personal computer, handheld computing device, Internet-enabled telephone, workstation, server, minicomputer, mainframe computer, or any other computing device. The computer can also include different bus configurations, networked platforms, multi-processor platforms, etc. Various operating systems can be used including Unix, Linux, Windows, Apple OS, and other suitable operating systems.

A network interface 215 enables the system 200 to communicate via a variety of communication networks, such as network 50 of FIG. 1

As illustrated in FIG. 1, the processing device of FIG. 2 may be coupled via a network 50 to other processing devices. In this implementation, one or more processing devices may comprise a server providing an output in the form of applications or web pages to other devices. Remote implementation of the prediction methods on one processing device shown in FIG. 1 by other processing devices coupled via the network are contemplated. Network 50 may be a public network, a private network or a combination of public and private networks.

FIG. 3 is a flowchart illustrating one embodiment of a method in accordance with the present technology. The method of FIG. 3 is conceptually divided into two phases: a development phase represented by block 310 and an analysis phase in block 330. In one embodiment, the steps in block 310 may be performed by a predictive model developer or system administrator using the development system 102 of FIG. 1, and those in block 330 performed by a user or client, such as a healthcare provider or insurer, operating a client system 130. In another embodiment, all steps—both in the development phase and the analysis phase—may be performed by the same user or group of users.

The analysis 330 may be performed by one or more of the applications 115 illustrated in FIG. 1. In one embodiment, the analysis 330 is performed by a healthcare facility manager utilizing application 115 to determine healthcare facility patient readmission risk within 30 days following an emergency department visit.

At step 312 an enterprise data warehouse is constructed. Construction of the data warehouse comprises entering (manually inputting or electronically retrieving, accessing and/or loading) health information data from individuals at 314, and adding and correlating demographic data to the health data 316. In one embodiment, step 314 may comprise accessing health data information from a health information exchange. A health information exchange (HIE) aggregates healthcare information electronically across organizations within a region, community or hospital system. In one embodiment, an enterprise data warehouse consisting of all a given states' HIE aggregated patient histories may be created. In a test implementation of the technology herein, patient records from the State of Maine HIE were used in modeling. Incorporated data elements from EMR systems may include patient demographic information, laboratory tests and results, radiographic procedures, medication prescriptions, diagnosis and procedures which are coded according to the International Classification of Diseases, 9^{th} Revision, Clinical Modification (ICD-9-CM). Census data from the U.S. Department of Commerce Census Bureau may be integrated into the data warehouse at 316 to provide approximation on patients' socioeconomic status information in terms of the average household mean and median family income and average degree of educational attainment, based on residence zip codes.

At 318, a predictive model is created as described below with respect to FIG. 4. The predictive model is in one embodiment created by using a cohort created from a year's worth of health data from a given year. At 320, optionally, the model may be validated. In a test system, utilizing the aforementioned HIE data, the model was validated by a subsequent year prospective cohort. Both the respective (model development) and prospective cohorts' individuals had similar demographics and one-year comprehensive clinical histories before the discharged date.

FIG. 4 illustrates one implementation of steps 318 of FIG. 3. With reference to FIG. 4, in one embodiment, modeling the predictive algorithm for use by a modeling application 115 begins by creating a series of sub-cohorts from the data warehouse at 410. In one exemplary implementation, a retrospective (model development) cohort of 293,461 ED encounters between Jan. 1, 2012 and Dec. 31, 2012, was assembled to develop a predictive model to the likelihood of ED revisits within 30 days after discharge. This retrospective cohort may be broken into three sub-cohorts of approximately equal size for use in model building, calibrating and evaluating the cohort.

At 412, features are selected from the data warehouse feature set. In one embodiment, the features are computationally selected as described herein. In the data warehouse healthcare data, 14,680 different features describe a profile of patient clinical history. For a number of individuals, many of these features have no data (e.g. a data value of zero). As such, and as explained further below, a feature selection process using the data variance may be exploited before the modeling process may be performed to reduce feature redundancy.

In one embodiment, 127 features in the prior 12 months to the ED discharge date were selected as inputs for the creation of a prospective analysis modeling. One of the key features in the data set may be whether the patient had a chronic medical condition. This feature may be defined using the AHRQ Chronic Condition Indicator (CCI) which provides an effective way to categorize ICD-9-CM diagnosis codes into one of two categories: chronic and non-chronic

At 414, two rounds of a decision tree modeling and variance analysis may be utilized sequentially to perform feature selection. 127 out of 14,680 features may be chosen for the final predictive model development.

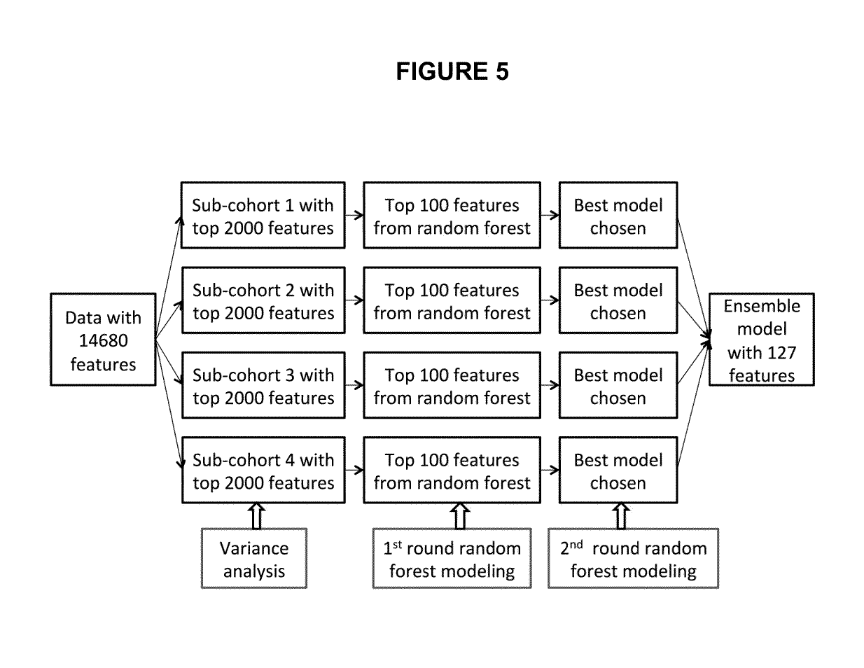

FIG. 5 represents the feature selection process. To identify the discriminant features and avoid under and/or over fitting during the statistical learning, 2000 features were first selected from the 14,680 features. Then a random forest model may be built based on these 2000 features. The top 2000 features of sufficient variation and eliminating those which had no data. In FIG. 5, four sub-cohorts are used for feature selection. Variance analysis is firs performed on each sub-cohort of 200 features, followed by a first round of modeling to find the top 100 features thereby creating a list of the features and their importance from the random forest model. A second round modeling may be thereafter done by using the top 10, 20, 30, 40, 50, 60, 70, 80, 90, 100 features from the feature list. A best ensemble model may be chosen according to the performance of sensitivity, specificity and PPV.

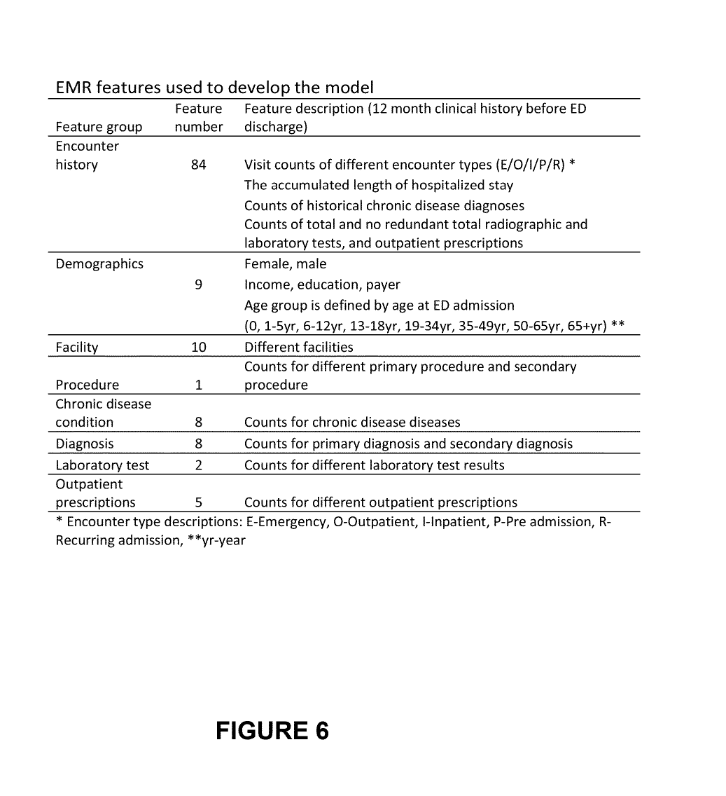

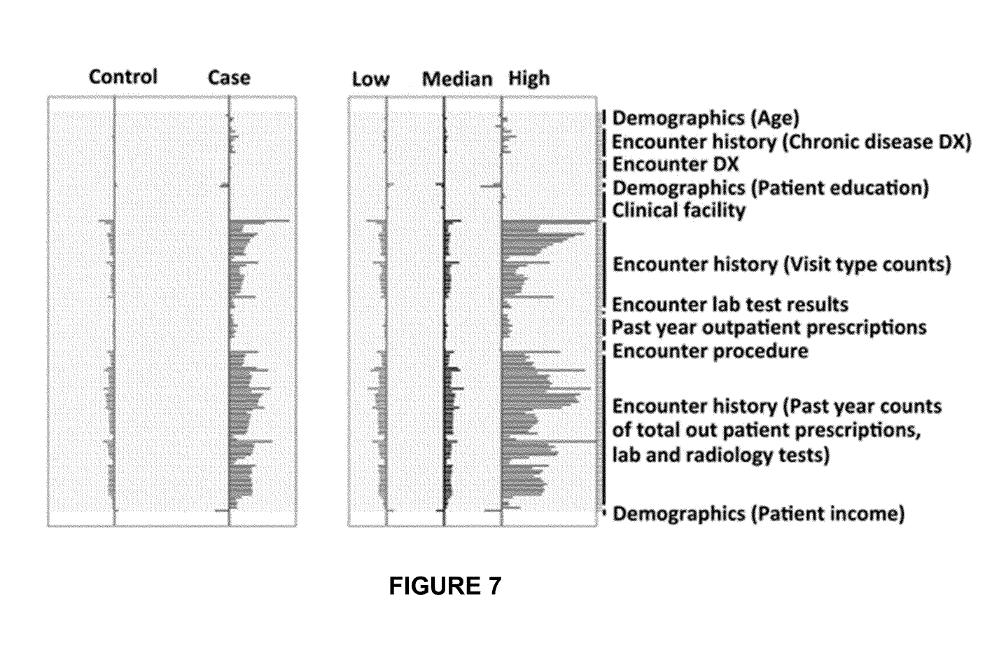

As illustrated in FIG. 6, 127 variables predictive of future 30-day risk of ED visit were identified: demographics groups (9), different encounter history (84), care facilities (10), primary and secondary diagnoses (8), primary and secondary procedures (1), chronic disease condition (8), laboratory test results (2), and outpatient prescription medications (5). These features' shrunken difference were grouped according to the risk level categories identified above, as illustrated in FIG. 7. These discriminant features' absolute values of the shrunken differences, among the low, medium, and high risk outcomes, differed more than the case (with future ED) and control (without future ED) outcomes, prospectively demonstrating the effectiveness of these features in the risk stratification. FIG. 7 illustrates the shrunken difference for the selected features used to develop the ED risk model graphed in order to measure the feature abilities in discriminating different classes. In FIG. 7, the x axis is the shrunken difference of each feature listed along the y axis, which is a measure of the difference between the standardized mean value of a feature within a specific class and the overall mean value of that feature. The shrunken differences of these discriminative features were much more pronounced in the low/medium/high risk cohort, demonstrating the effectiveness of these features in prospectively differentiating the targeted outcomes.

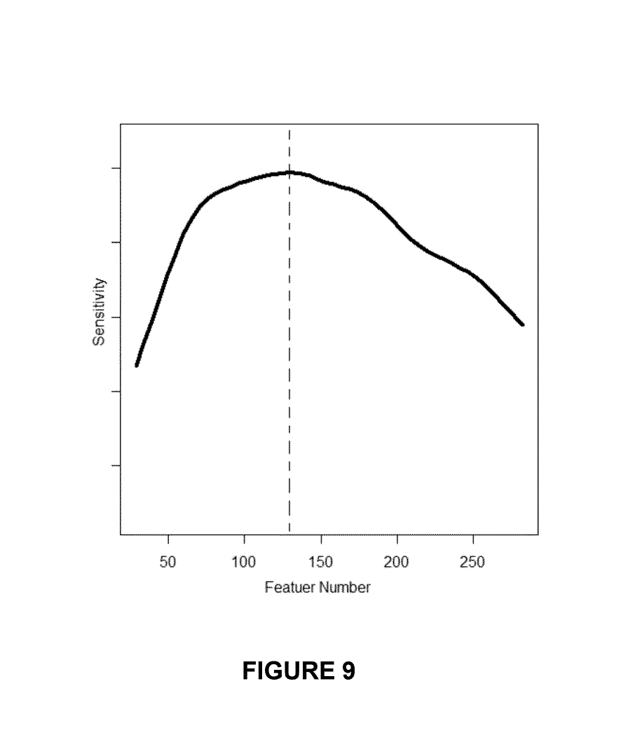

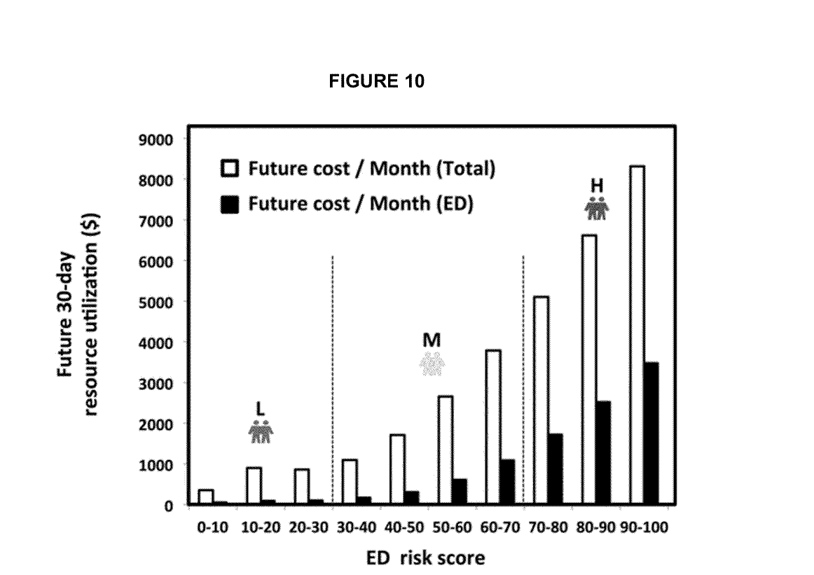

Sensitivity may be plotted as a function of feature numbers as illustrated in FIG. 9. As shown in FIG. 9, optimal learning and avoidance of under or over fitting is achieved by 127 features selected.

Returning to FIG. 5, at 416, the predictive model algorithm is created based on the 127 factors selected. In one embodiment, a “survival forest” of forecasting decision trees is developed using a prior year clinical history for a given data set used in development (the respective, development cohort), and ranked according to the corresponding posterior probability. Specifically, a ‘tree’ model may be developed using the prior year clinical history (‘Data’). First, a general technique of bootstrap aggregating (or bagging) may be applied to randomly bootstrap sample of the entire training cohort for growing the tree. Next, the survival trees are grown based on the randomly selected predictors via log-rank survival splitting rule on each survival tree node:

$$L ( x , c ) = \frac{{\sum }_{i = 1}^{N} ( {d}_{i , 1} - {Y}_{i , 1} \frac{{d}_{i}}{{Y}_{i}} )}{\sqrt{{\sum }_{i = 1}^{N} \frac{{Y}_{i , 1}}{{Y}_{i}} ( 1 - \frac{{Y}_{i , 1}}{{Y}_{i}} ) ( \frac{{Y}_{i} - {d}_{i}}{{Y}_{i} - 1} ) {d}_{i}}}$$

where, c is the split value for predictor x; and

d_{i,j} and Y_{i,j} for node h equal the number of patients who have ED return event in tᵢ day after discharge and who never come back in tᵢ day after discharge for daughter nodes j=1, 2.

Hence, Y_{i,1}=|{T_{I}>=tᵢ& xᵢ<=c}| and Y_{i,2}=|{T_{I}>=tᵢ& xᵢ>c}|, where T_{I} is the days that the patient came back to ED after discharge for the individual I.

The value |L(x, c)| is a measure of node separation, which quantifies splitting for the predictor x when split value equal c. Therefore, the optimized predictor x* and split value c* at node h is determined by maximizing the |L(x*, c*)|>=|L(x, c)| for all x and c.

Third, an ensemble cumulative hazard estimate is created by combining information from the survival trees so that each individual will be assigned one estimate:

$${\hat{H}}_{h} ( t ) = {\sum }_{{t}_{l , h} \leq t}^{ } \frac{{d}_{l , h}}{{Y}_{l , h}}$$

Where Ĥₕ(t) is the cumulative hazard estimate for node h;

t_{i,h} is the distinct death times in node h;

d_{I,h} and Y_{I,h} represent the number of deaths and individuals at risk at time t_{i,h}.

The cumulative hazard estimate Ĥh(t) may be computed for each terminal node for each predictor (factor) xᵢ for individual sample i which drops down into in the tree. In one implementation, three-hundred notes (ntree=300) may be used to grow the “survival forest”, and ensemble the cumulative hazard estimate for each tree together within the forest to calculate final predictive scores for each individual patient. Therefore,

$${\hat{H}}_{e} ( t \vert {x}_{i} ) = \frac{1}{ntree} {\sum }_{b = 1}^{ntree} {\hat{H}}_{b} ( t \vert {x}_{i} )$$

Here b denotes the individual tree and ntree is the number of trees in survival forest. The result of the hazard estimate is a quantification of the effect of each factor on the likelihood of an ED return, allowing selection or discarding of the factor for use in building the predictive model.

Next, at 418, risk calibration may be performed. A second sub-cohort may be used to calibrate the predictive scores calculated above by creating a risk measure for each score.

Applying the above model to each sample i in the second sub-cohort, the derived predictive scores Ĥₑ(t|xᵢ),i=1, . . . N may be ranked.

For each value of T, one can calculate the positive predictive value (PPV) as follows:

$$PPV = f ( T ) = {\sum }_{i = 1}^{N} I ( {\hat{H}}_{e} ( t \vert {x}_{i} ) - T ) J ( {x}_{i} ) ) / {\sum }_{i = 1}^{N} I ( {\hat{H}}_{e} ( t \vert {x}_{i} ) - T )$$

$$where$$

$$I ( x ) = \{ \begin{matrix}1 & x > 0 \\ 0 & other\end{matrix} \} J ( x ) = \{ \begin{matrix}1 & x ∈ {X}_{case} \\ 0 & x ∈ {X}_{ctrl}\end{matrix} \}$$

and X_{case} and X_{ctrl} denote the patients who have and have never had ED revisits, respectively, within 30 days after discharge.

As a result, a modeling function mapping predictive values to PPVs is provided. Each sample (or individual) i may be assigned a PPV to estimate the risk of becoming a case (having ED revisit in 30 days) with the given score. The PPV values may be converted to a value ranging from 0-100 to define a risk level. For example, a sample had a predicted value associated with PPV index of 80 meant this sample had 80% probability to make ED return in 30 days. Its risk level is 80.

Next at 420, the performance of the predictive model may be evaluated. In one embodiment, this step need not be performed. After calibration, the model's performance may be blind tested by a third sub-cohort to assess the model and calibration values derived from steps 416 and 418. For evaluation purposes, the derived model is applied to each sample i in the third sub-cohort to derive the predictive scores Ĥₑ(t|xᵢ),i=1, . . . N and risk levels according the PPV-score mapping. The AUC score for the third sub-cohort may be calculated. The derived predictive scores Ĥₑ(t|xᵢ),i=1, . . . N were ranked, and the AUC score may be computed as follows:

$$AUC = \frac{1}{nm} {\sum }_{i = 1}^{n} {\sum }_{j = 1}^{m} I ( {\hat{H}}_{e} ( t \vert {x}_{i} ) > {\hat{H}}_{e} ( t \vert {x}_{j} ) )$$

The model of FIG. 4 results in an ED revisit prediction algorithm to measure a statewide post discharge 30-day ED revisit risk.

Returning to FIG. 3, step 330 illustrates multiple analyses which may be performed using the predictive model of the present technology. At 342, data for a subject individual or set of individuals may be entered into the modeled analysis application. The application may provide any number of distinct types of analyses, illustrated herein, and based on the type of analysis used, the data entered at 342 may be for one or more individuals having a history of ED visits within a given time period, such as one year.

Exemplary types of analyses which may occur include validating a predictive risk for an individual at 352, clustering patients into subpopulations based on risk and/or demographics at 354, identifying high-risk subjects at 356, and evaluating economics of the healthcare facility at 358, including the cost of re-admission of a repeat ED visitor within a 30 day window following an initial visit. Once any of these analyses have been made, the modeled analysis application 115 can output results at 360. Examples of those results are illustrated herein.

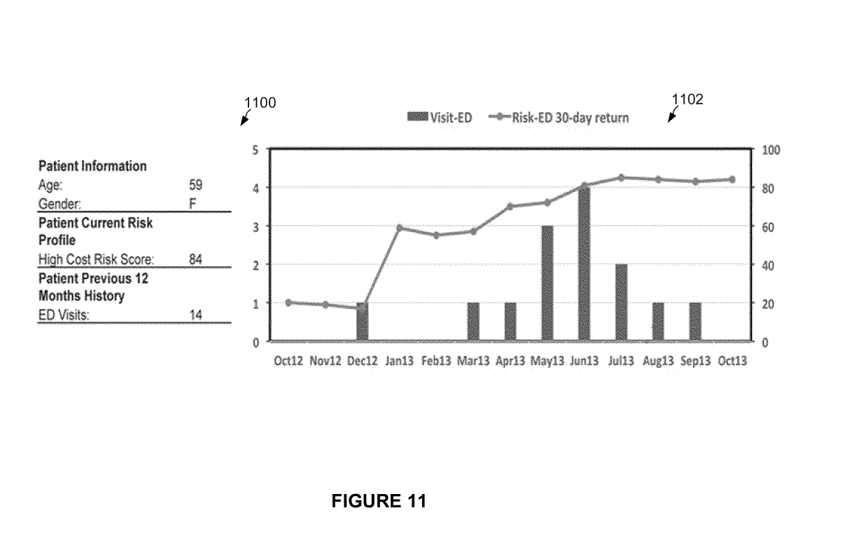

At 356, the predictive modeling application may be utilized to compute predictive values to PPVs, each sample (or individual) i may be assigned a PPV to estimate the risk of becoming a case (having ED revisit in 30 days) with the given score. The PPV values may be converted to a value ranging from 0-100 to define a risk level. For example, a sample with a predicted value associated with PPV index of 80 means sample has an 80% probability to make ED return in 30 days. Its risk level is 80. A prospective case-study chart, for a patient randomly selected from the prospective cohort, may be shown in FIG. 11. In this case study chart, the left summary 1102 shows that this patient is a 59 year old female who had 14 emergency department visits in the last 12 month period, while the chart 1102 shows the timing of each encounter along with the risk scores increasing over time. As the risk score changed longitudinally from low risk (<20) to high risk (>80), the corresponding ED 30-day visit count increased accordingly from 0 to a peak value of 4. The correlation between the 12-month profile of the ED visits and risk score indicated the utilities of the predictive model.

In one embodiment, one may utilized thresholds from the mapping to determine risk groups: For two thresholds Tₕ, Tₘ:

f(Tₕ)=0.7

f(Tₘ)=0.3

Patients may be grouped into three risk groups

High risk group: Ĥₑ(t|xᵢ)>Tₕ

Intermediate risk group: Tₘ<Ĥₑ(t|xᵢ)<Tₕ

Low risk group: Ĥₑ(t|xᵢ)<Tₘ

Use of ED scoring metric to forecast the economic impact of ED revisits at 358 may include use of the ED revisit risk scoring metric to forecast future ED results from computing each encounter-based cost, and each subject's future cost values were estimated based on a combination of encounter types (surgical/medical outpatient, ED visit, and inpatient), diagnosis, and procedure CCS group. An estimated cost may be calculated as:

Estimated_Cost=$2150×OS+$170×OM+$925×E+Σᵢ₌₁^{m}I(Cᵢ)×LOSᵢ

where OS, OM, E are the surgical outpatient, medical outpatient, emergency visit counts respectively in future 30 days after discharge; LOSi is inpatient length of day for ith inpatient encounter within 30 days after discharge; and I(Ci) is the cost map function presenting the cost per day for specific inpatient diagnosis, and procedure category Ci.

The resource utilization of all different encounters or ED encounters for each patient, post ED discharge future 30 days, may be summarized at different risk levels defined by the predictive model.

Another output of the application may comprise the unsupervised clustering of high risk ED patients to reveal distinctive sub-populations for targeted care at 354. To reduce high dimensional EMR features, principle component analysis (PCA) may be used to divide the high risk patients of 30-day ED return identified by the prospective model into distinctive groups, based on demographics, primary diagnosis and procedure, and chronic disease conditions. The features for high-risk patients are projected to a lower dimensional subspace with largest variances:

Tᵢ^{k}=Xᵢ·wₖ

where Xi is EMR feature matrix for each high-risk patient, and wk is the set of vectors of weights that map each patient feature vector Xi to a new vector of principal component scores Tik.

w1 may be computed solving the following objective functions (1) and (2) and wk by iterating objective function (3) based on the first k−1 principal components:

$${w}_{1} = arg {max}_{‖ W ‖ = 1} \{ {\sum }_{i}^{ } {( {T}_{i}^{1} )}^{2} \} = arg {max}_{‖ W ‖ = 1} \{ {\sum }_{i}^{ } {( {X}_{i} \cdot w )}^{2} \}$$

A K-means algorithm may be applied on the top of principal components Tik subspace of PCA to find potential patient patterns for 30-day ED return. A value of K=6 may be used to implement initial k means set for the algorithm and calculate the Euclidean centroid m to generate finial clusters

$${m}_{i}^{t + 1} = \frac{1}{\vert {C}_{i}^{t} \vert} {\sum }_{{x}_{j} ∈ {C}_{i}^{t}}^{ } {x}_{j} ,$$

where Ci is the ith cluster in total 6 clusters, and x represents the previous principal components Tk.

Unique patterns revealed by the clustering results may be analyzed to characterize the high-risk subjects identified by the predictive ED algorithm.

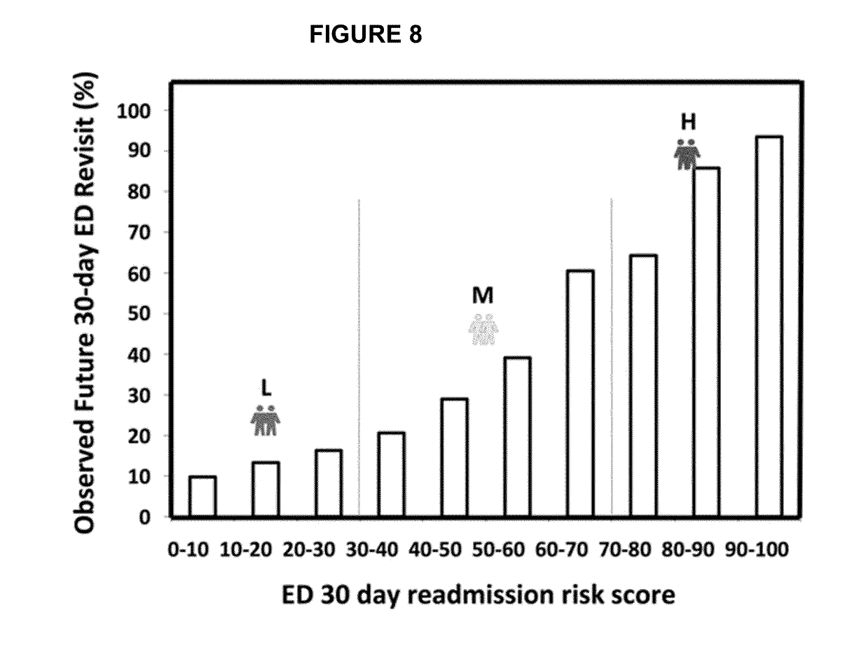

Another use of the application is to identify high risk patients. The predictive algorithm can be used to assign a risk score (from 0 to 100) for each patient at ED discharge to assess the risk of ED revisit. The trending of PPVs relative to observed rates of future 30-day ED returns is illustrated in FIG. 8. The PPV values increase monotonically as the risk scores went high. When the risk score may be more than 60, the model identified more than 60% of the ED 30 day revisits in prospective tests. With a risk score higher than 90, 93.5% of prospective revisits were identified correctly. At risk scores between 30 and 40 in prospective analysis, the algorithm found a fairly impressive percentage (24.4%) of all ED revisits. Sensitivities decreased with the risk increase, up to 3.0% with scores higher than 70. The receiver operating characteristic curve analyses showed that there may be a 71.0% (retrospective) or 70.4% (prospective) probability that a randomly selected ED discharged patient with a 30-day post discharge ED revisit will receive a higher risk score than a randomly selected patient who will not have a future 30-day ED revisit.

Unscheduled ED revisits may occur for any reason and can be separated by days, weeks, months or years. ED revisits could be due to the received poor quality or for unexpected complications. When selecting an appropriate time period for the revisit, consideration was given to selecting a time interval that allows for the same risk of exposure of all patients as a population, within which the revisits tended to raise healthcare utilization issues.

The application user interface may include, for example, a prospective utilization interface integrating the predictive algorithm with a visualization dashboard, allowing age-group filters to examine prospectively the model performance in different age sub cohorts. In one exemplary implementation, the PPV and sensitivity above a risk score of 80 were 75.6% and 2.9% for patients at 13-18 age group, 81.6% and 11.2 for patients at 19-34 age group, 85.4% and 13.7% for patients at 35-49 age group, 83.9% and 10.2% for patients at 50-65 age group, and 76% and 2.6% for patients above 65 age group. In addition, pediatric patents are unique in clinical research and need special attention as a future direction of predictive analytics.

Learning the unique patterns of the patients with high risk of reusing the medical service is another application of the predictive model. Unsupervised clustering analysis revealed six clinically relevant subgroups among the high-risk patient population that were confirmed as durable. These subgroups had unique patterns of demographics, disease severities, comorbidities and resource consumption. This finding revealed a new opportunity for targeted and proactive intervention to prevent ED revisit. For example, cluster #5 and #6 both represented 0.2% of the entire prospective cohort consuming 25.3% (cluster #5) and 14.6% (cluster #6) of all ED revisit high-risk group resource utilization (total medical expense), which agreed with the findings from other studies that there were few percentage of people consuming relatively high resource. A decreased prevalence of the co-occurring chronic conditions in four other cluster groups of relatively younger adults with much less resource consumption. 29.0% of cluster #3 subjects, who were not associated with any chronic disease history, may benefit from targeted care management to keep them out of the emergency room. Currently, many existing care management strategies are directed toward single conditions. The use of this model will benefit both healthcare providers and patients, health care providers can reasonably estimate the ED revisit risks at the patient discharge time. Such pre-knowledge will provide a perspective of health care economics for the future clinical resource related to ED

Healthcare resources distributed among the inpatient, outpatient, ED and others could be balanced and re-allocated in advance with consideration of the forecasted future ED reuse. In this regard, the identification of the high-risk group can lead to targeted care with better patient experience, and effective resource utilization. In addition, as an early warning tool, the predicted ED revisit risk profiles can raise patients' self-awareness to achieve better self-management. Therefore, the integration of the risk modeling application can improve care quality and drive the reduction of the unnecessary ED revisits.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method of providing an analysis of a patient population under examination based on gathered health data for the patient population, comprising:
accessing a data store of historical patient data representing clinical history of each patient in the patient population, the data characterized by a set of factors characterizing health care visits;
calculating an individual hazard estimate (Ĥₑ) for each individual patient in the data store based on a subset of factors computationally selected from the set of factors;
for each of a number of days T following a healthcare visit, calculating a risk score of the form:
$$PPV = f ( T ) = {\sum }_{i = 1}^{N} I ( {\hat{H}}_{e} ( t \vert {x}_{i} ) - T ) J ( {x}_{i} ) ) / {\sum }_{i = 1}^{N} I ( {\hat{H}}_{e} ( t \vert {x}_{i} ) - T )$$
$$where$$
$$I ( x ) = \{ \begin{matrix}1 & x > 0 \\ 0 & other\end{matrix} \} J ( x ) = \{ \begin{matrix}1 & x ∈ {X}_{case} \\ 0 & x ∈ {X}_{ctrl}\end{matrix} \}$$
and X_{case} comprises a number of patients having health care visits and X_{ctrl} denotes who have never had healthcare revisits within a period after discharge from a healthcare facility; and
outputting an analysis of data in the data store based on the risk score.

2. The computer implemented method of claim 1 wherein subset of factors comprises at least one factor selected from an encounter history, patient demographics, facility identification, medical procedure type, chronic disease conditions, diagnosis type, laboratory test types and outpatient prescriptions.

3. The computer implemented method of claim 1 wherein the subset is calculated from two rounds of a decision tree modeling and variance analysis may be utilized sequentially to perform feature selection for the subset.

4. The computer implemented method of claim 2 wherein the encounter history includes each of visit counts of different encounter types; an accumulated length of hospitalized stay; counts of historical chronic disease diagnoses; and counts of total and no redundant total radiographic and laboratory tests, and outpatient prescriptions.

5. The computer implemented method of claim 1 wherein the individual hazard estimate based on an ensemble cumulative hazard estimate, the individual hazard estimate comprises:
$${\hat{H}}_{e} ( t \vert {x}_{i} ) = \frac{1}{ntree} {\sum }_{b = 1}^{ntree} {\hat{H}}_{b} ( t \vert {x}_{i} )$$
Where b denotes the individual tree and ntree is the number of trees in survival forest, and xᵢ is a factor in the subset of factors and t is the time in days.

6. The computer implemented method of claim 5 wherein the ensemble cumulative hazard estimate comprises
$${\hat{H}}_{h} ( t ) = {\sum }_{{t}_{l , h} \leq t}^{ } \frac{{d}_{l , h}}{{Y}_{l , h}}$$
where Ĥₕ(t) is the cumulative hazard estimate for node h; t_{i,j} is the distinct death times in node h; and d_{i,h}, and Y_{i,h} represent the number of deaths and individuals at risk at time t_{i,h}.

7. The computer implemented method of claim 1 wherein the outputting comprises outputting a classification of patients into a risk category, or a cluster of patients into subpopulation based on an analysis of the risk score.

8. A processor implemented method of displaying a risk assessment to a healthcare provider, comprising
accessing an evaluation data store of historical patient data representing clinical history of each patient in the patient population, the data characterized by a set of factors characterizing health care visits;
calculating a risk score for each patient, the risk score based on a computation created from a modeling data store including a first data set comprising a history of medical facility visits accessed from a health information exchange, each visit characterized by a set of factors, the calculating based on a subset of factors computationally selected based on a likelihood of each factor selected producing a medical facility visit; and
outputting an analysis of data in the evaluation data store based on the risk score.

9. The processor implemented method of claim 8 wherein the calculating a risk score includes:
calculating an individual hazard estimate (Ĥₑ) for each individual patient in the evaluation data store based on a subset of factors computationally selected from the set of factors;
for each of a number of days T following a healthcare visit, calculating the risk score of the form:
$$PPV = f ( T ) = {\sum }_{i = 1}^{N} I ( {\hat{H}}_{e} ( t \vert {x}_{i} ) - T ) J ( {x}_{i} ) ) / {\sum }_{i = 1}^{N} I ( {\hat{H}}_{e} ( t \vert {x}_{i} ) - T )$$
$$where$$
$$I ( x ) = \{ \begin{matrix}1 & x > 0 \\ 0 & other\end{matrix} \} J ( x ) = \{ \begin{matrix}1 & x ∈ {X}_{case} \\ 0 & x ∈ {X}_{ctrl}\end{matrix} \}$$
and X_{case} comprises a number of patients having health care visits and X_{ctrl} denotes who have never had healthcare revisits within a period after discharge from a healthcare facility.

10. The processor implemented method of claim 9 wherein subset of factors comprises at least one factor selected from an encounter history, patient demographics, facility identification, medical procedure type, chronic disease conditions, diagnosis type, laboratory test types and outpatient prescriptions.

11. The processor implemented method of claim 10 wherein the encounter history includes each of visit counts of different encounter types; an accumulated length of hospitalized stay; counts of historical chronic disease diagnoses; and counts of total and no redundant total radiographic and laboratory tests, and outpatient prescriptions.

12. The processor implemented method of claim 9 wherein the individual hazard estimate based on an ensemble cumulative hazard estimate, the individual hazard estimate comprises:
$${\hat{H}}_{e} ( t \vert {x}_{i} ) = \frac{1}{ntree} {\sum }_{b = 1}^{ntree} {\hat{H}}_{b} ( t \vert {x}_{i} )$$
where b denotes the individual tree and ntree is the number of trees in survival forest, and xᵢ is a factor in the subset of factors and t is the time in days.

13. The processor implemented method of claim 12 wherein the ensemble cumulative hazard estimate comprises
$${\hat{H}}_{h} ( t ) = {\sum }_{{t}_{l , h} \leq t}^{ } \frac{{d}_{l , h}}{{Y}_{l , h}}$$
where Ĥₕ(t) is the cumulative hazard estimate for node h; t_{i,h} is the distinct death times in node h; and d_{i,h} and Y_{i,h} represent the number of deaths and individuals at risk at time t_{i,h}.

14. A computer readable medium including code instructing a processor, the code comprising:
code adapted to instruct a processor to access an evaluation data store of historical patient data representing clinical history of each patient in the patient population, the data characterized by a set of factors characterizing health care visits;
code adapted to instruct a processor to calculate an individual hazard estimate (Ĥₑ) for each individual patient in the evaluation data store based on a subset of factors computationally selected from the set of factors;
code adapted to instruct a processor to calculate a risk score for each of a number of days T following a healthcare visit, the risk score of the form:
$$PPV = f ( T ) = {\sum }_{i = 1}^{N} I ( {\hat{H}}_{e} ( t \vert {x}_{i} ) - T ) J ( {x}_{i} ) ) / {\sum }_{i = 1}^{N} I ( {\hat{H}}_{e} ( t \vert {x}_{i} ) - T )$$
$$where$$
$$I ( x ) = \{ \begin{matrix}1 & x > 0 \\ 0 & other\end{matrix} \} J ( x ) = \{ \begin{matrix}1 & x ∈ {X}_{case} \\ 0 & x ∈ {X}_{ctrl}\end{matrix} \}$$
and X_{case} comprises a number of patients having health care visits and X_{ctrl} denotes who have never had healthcare revisits within a period after discharge from a healthcare facility; and
code adapted to instruct a processor to output an analysis of data in the data store based on the risk score to a display device.

15. The computer readable medium of claim 14 wherein the subset of factors comprises at least one factor selected from an encounter history, patient demographics, facility identification, counts for different primary and secondary procedures, counts for chronic diseases, counts for primary and secondary diagnosis, counts for different laboratory test results and counts for different outpatient prescriptions.

16. The computer readable medium of claim 15 wherein the individual hazard estimate based on an ensemble cumulative hazard estimate, the individual hazard estimate comprises:
$${\hat{H}}_{e} ( t \vert {x}_{i} ) = \frac{1}{ntree} {\sum }_{b = 1}^{ntree} {\hat{H}}_{b} ( t \vert {x}_{i} )$$
Where b denotes the individual tree and ntree is the number of trees in survival forest, and xᵢ is a factor in the subset of factors and t is the time in days.

17. The computer readable medium of claim 16 wherein the ensemble cumulative hazard estimate comprises
$${\hat{H}}_{h} ( t ) = {\sum }_{{t}_{l , h} \leq t}^{ } \frac{{d}_{l , h}}{{Y}_{l , h}}$$
where Ĥₕ(t) is the cumulative hazard estimate for node h; t_{i,h} is the distinct death times in node h; and d_{i,h}, and Y_{i,h} represent the number of deaths and individuals at risk at time t_{i,h}.

18. The computer implemented method of claim 17 wherein the outputting comprises outputting a classification of patients into a risk category, or a cluster of patients into subpopulation based on an analysis of the risk score.
